(19) United States
(12) Patent Application Publication
(10) Pub. No.: US 2016/0327522 A1
(43) Pub. Date: Nov. 10, 2016

(54) ABNORMAL SOUND DETECTION DEVICE, ABNORMAL PROCESSING-MACHINE-SOUND DETECTION SYSTEM, AND ABNORMAL SOUND DETECTION METHOD

(71) Applicant: Mitsubishi Electric Corporation, Tokyo (JP)

(72) Inventors: Nobuaki TANAKA, Tokyo (JP); Atsuyoshi YANO, Tokyo (JP); Jin HIRANO, Tokyo (JP); Atsushi HOTTA, Tokyo (JP)

(73) Assignee: MITSUBISHI ELECTRIC CORPORATION, Tokyo (JP)

(21) Appl. No.: 15/109,360

(22) PCT Filed: Jan. 29, 2015
(86) PCT No.: PCT/JP2015/052534

§ 371 Date: Jun. 30, 2016

(30) Foreign Application Priority Data
Feb. 17, 2014 (JP) 2014-027601

(51) Int. Cl. G01N 29/14; G01N 29/44

(52) U.S. Cl. CPC G01N 29/14; G01N 29/4463

(57) ABSTRACT

Including an invariant interval deciding unit (1) to decide whether operation of a detection target is in an invariant interval; a correction parameter generator (3) to generate, when decided that the operation is in the invariant interval, a correction parameter for correcting an observation signal in a time interval outside the invariant interval from an observation signal obtained from the operation sound in the invariant interval; a feature extracting unit (4) to extract, when decided that the operation is in the time interval outside the invariant interval, a feature value of the operation sound of the detection target in the time interval outside the invariant interval from the observation signal of the detection target in the time interval outside the invariant interval and the correction parameter; and an abnormal sound deciding unit (5) to decide from the feature value extracted whether an abnormal sound occurs in the detection target.

### TECHNICAL FIELD

The present invention relates to a technique that monitors an operation sound of equipment to detect an abnormal sound produced owing to an abnormal operation of the equipment.

### BACKGROUND ART

First, as equipment as an abnormal sound detection target, there are such machines as NC (Numerical Control) processing machines. The NC processing machines include a laser processing machine, NC cutting machine, and NC lathe, for example.

To detect an abnormal sound from an operation sound of the equipment as a detection target, it is necessary to extract a feature value that expresses a feature of the abnormal sound numerically from the operation sound of the equipment. Various extracting methods of the feature value of the abnormal sound (simply referred to as “feature value” from now on) have been disclosed conventionally.

For example, a Patent Document 1 discloses a method of employing as a feature value of an abnormal sound a peak value of a time waveform when dividing an observation signal of a sensor that observes the operation of equipment into several frequency bands. In addition, a Patent Document 2 discloses a method of plotting the root mean square of an observation signal of a sensor on a plane, and then employing as a feature value a mean level of portions greater than a prescribed threshold or a mean level of portions not greater than the threshold.

In addition, a Patent Document 3 discloses a method of employing a result obtained by dividing a peak value of a frequency spectrum of an observation signal of a sensor by the mean value of the spectrum as one of the feature values. The feature value indicates the degree of changes of the spectrum with respect to the mean value. Thus, since it is a dimensionless number normalized by the sensitivity of the sensor, it is independent of the sensitivity of the sensor or a mounting position so that the same feature value is extracted as long as the operation sound of the equipment to be observed is the same. Accordingly, even when the type of the sensor or its mounting conditions are changed, the correction parameter need not be set again.

### PRIOR ART DOCUMENT

### Patent Document

### Patent Document 1: Japanese Patent Laid-Open No. 2008-076246.

### Patent Document 2: Japanese Patent Laid-Open No. 2007-114052.

### Patent Document 3: Japanese Patent Laid-Open No. 2003-214944.

### DISCLOSURE OF THE INVENTION

### Problems to be Solved by the Invention

However, in the extracting methods of the feature value disclosed in the foregoing Patent Document 1 and Patent Document 2, even if the operation sound of the equipment which is the detection target is the same, the feature value extracted alters depending on the type of the sensor used and the setting conditions such as the mounting position of the sensor and the sensitivity of the sensor. Accordingly, even if a threshold of the feature value suitable for the abnormal sound detection in the settings of a particular sensor is determined, the threshold is not applicable to a different sensor or different setting conditions. Accordingly, when changing a sensor or settings of the sensor, it is necessary to reset the correction parameter such as a correction coefficient by which the observation signal of the sensor is multiplied, or to reset the threshold of the feature value, which presents a problem of incurring large operation expenses.

On the other hand, as for the technique disclosed in the foregoing Patent Document 3, it can extract the feature value unaffected by the difference in the type of the sensor or its setting conditions, and hence can obtain relative changes in the observation signal of the sensor. However, it has a problem of being unable to acquire the absolute amount of the observation signal of the sensor.

For example, during the cutting processing of a metallic plate by a laser processing machine, a processing condition can take place in which although a constant high sound pressure occurs as long as the cutting is performed normally, a constant low sound pressure is produced while an abnormality occurs. As for the processing condition, since the sound pressure is constant without varying with time either during the normal operation or during the abnormal operation of the laser processing machine, the feature value that acquires the relative changes as the technique disclosed in the Patent Document 3 is inappropriate, but a feature value that acquires the absolute amount like a sound pressure level is appropriate. However, to use the sound pressure level as the feature value, it is necessary to reset the correction parameter or the threshold of the feature value every time the type of the sensor or its setting conditions are changed as in the technique disclosed in the foregoing Patent Document 1 and Patent Document 2.

Thus, as for the techniques disclosed in the foregoing Patent Document 1 to Patent Document 3, they have a problem of requiring a correction procedure when changing the type of the sensor or its setting conditions, and to circumvent the correction procedure, they present a problem in that the feature extraction method that can be used is limited and the detection capability reduces.

The present invention is implemented to solve the foregoing problems. Therefore it is an object of the present invention to reduce the operation expenses of the correction procedure at a time of changing the type of the sensor or its setting conditions without reducing the detection capability of an abnormal sound.

### Means for Solving the Problems

An abnormal sound detection device in accordance with the present invention comprises: an invariant interval deciding unit to decide whether an operation of a detection target is an operation in an invariant interval or not by referring to state information indicating an operation state of the detection target, the invariant interval being a time interval in which an operation sound makes no difference whether the operation sound originates from a normal operation or from an abnormal operation of the detection target; a correction parameter generator to create, when the invariant interval deciding unit decides that the operation of the detection target is the operation in the invariant interval, a correction parameter for correcting an observation signal of the detection target in a time interval outside the invariant interval from an observation signal obtained by observing the operation sound of the detection target in the invariant interval; a feature extracting unit to extract, when the invariant interval deciding unit decides that the operation of the detection target is the operation in the time interval outside the invariant interval, a feature value of the operation sound of the detection target in the time interval outside the invariant interval in accordance with the observation signal of the detection target in the time interval outside the invariant interval and the correction parameter the correction parameter generator creates; and an abnormal sound deciding unit to decide whether the abnormal sound occurs in the detection target or not in accordance with the feature value the feature extracting unit extracts.

### Advantages of the Invention

According to the present invention, it can increase the degree of freedom for selecting a feature extraction method in the abnormal sound detection, and can achieve high detection capability. Furthermore, it can obviate the necessity of the correction processing when changing the type of the sensor or its setting conditions, and can reduce the operation expenses of the correction procedure.

### BRIEF DESCRIPTION OF THE DRAWINGS

FIG. 1 is a block diagram showing a configuration of an abnormal sound detection device of an embodiment 1;

FIG. 2 is a diagram showing an operation sound of a laser processing machine;

FIG. 3 is a flowchart showing the operation of the abnormal sound detection device of the embodiment 1;

FIG. 4 is a block diagram showing a configuration of an abnormal sound detection device of an embodiment 4; and

FIG. 5 is a flowchart showing the operation of the abnormal sound detection device of the embodiment 4.

### BEST MODE FOR CARRYING OUT THE INVENTION

The best mode for carrying out the invention will now be described with reference to the accompanying drawings to explain the present invention in more detail.

### Embodiment 1

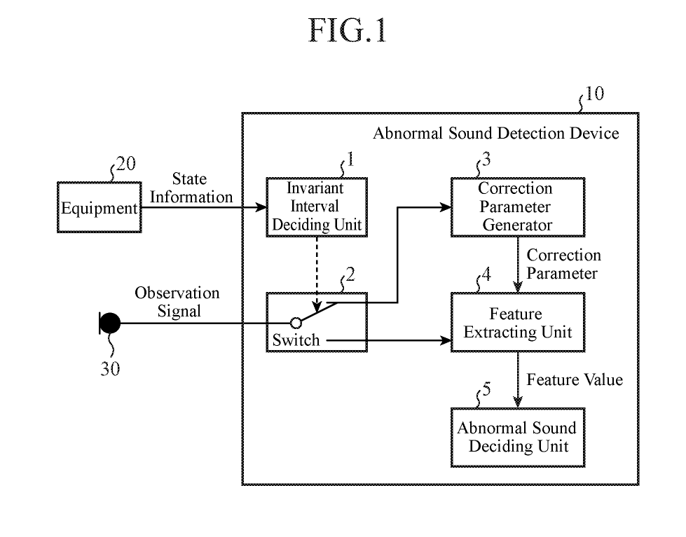

FIG. 1 is a block diagram showing a configuration of an abnormal sound detection device of an embodiment 1 in accordance with the present invention.

An abnormal sound detection device 10 comprises an invariant interval deciding unit 1, a switch 2, a correction parameter generator 3, a feature extracting unit 4 and an abnormal sound deciding unit 5. In addition, a target of detection (detection target) of the abnormal sound of the abnormal sound detection device 10 is equipment 20, and the equipment 20 comprises one or more sensors 30.

The following description will be made using a laser processing machine as an example of the equipment 20 which is the abnormal sound detection target. The abnormal sound detection device 10 in accordance with the present invention, however, is applicable to apparatuses other than the laser processing machine, and thus naturally includes a configuration using an apparatus other than the laser processing machine. Incidentally, an application using an apparatus other than the laser processing machine will be described later.

During metallic plate processing by the laser processing machine, a different operation sound will occur depending on whether the processing is performed normally or an abnormality takes place. Here, the occurrence of the abnormality refers to such a case where a molten metal spouts out onto the metallic plate when performing piercing (processing of making a hole in a material) or cutting the metallic plate with a laser. If such an abnormality occurs, it cannot only deteriorate the processing quality, but also cause damage to the laser processing machine. Thus, a control operation is desired such as automatically shutting down the operation of the laser processing machine in an emergency by detecting the occurrence of the abnormality. In the case of the laser processing machine, it carries out the control operation by detecting the operation sound during the abnormality as an abnormal sound.

The sensor 30 observes the operation of the equipment 20 which is the abnormal sound detection target. As the sensor 30, a microphone or a vibration sensor (acceleration sensor) is applicable, for example. Incidentally, the following shows an example in which the sensor 30 is comprised of a microphone and observes the operation sound of the laser processing machine which is the equipment 20. In addition, although the following shows an example that has only one microphone mounted, the number of microphones to be arranged is not limited to one. For example, a configuration is also possible which performs beamforming using a plurality of microphones to observe the operation sound of the equipment 20 more clearly and accurately.

During the operation of the equipment 20, the invariant interval deciding unit 1 decides, by referring to state information delivered from the equipment 20, whether the operation of the equipment 20 is in a time interval during which the operation sound makes no difference whether it originates from a normal operation or an abnormal operation of the equipment 20 (referred to as “invariant interval” from now on), such as a time interval which produces an invariant operation sound (also referred to as “invariant interval” from now on). The decision processing is carried out in either case where the equipment 20 operates normally or abnormally. As for a decision method of the invariant interval, the equipment 20 is set in such a manner as to transmit a trigger signal at the starting time and ending time of an invariant interval, for example, and the invariant interval deciding unit 1 decides the invariant interval according to the trigger signals transmitted.

Alternatively, a configuration is also possible in which the equipment 20 transmits a trigger signal only at the starting time of the invariant interval, and the invariant interval deciding unit 1 designates as the invariant interval a prescribed time interval in the processing, which is set in advance from receiving the trigger signal. More specifically, when setting as the invariant interval a time interval of 0.5 second from receiving the trigger signal at the starting time of the invariant interval, the invariant interval deciding unit 1 decides that an interval within 0.5 second from receiving the trigger signal as the invariant interval, but that an interval exceeding 0.5 second is not the invariant interval.

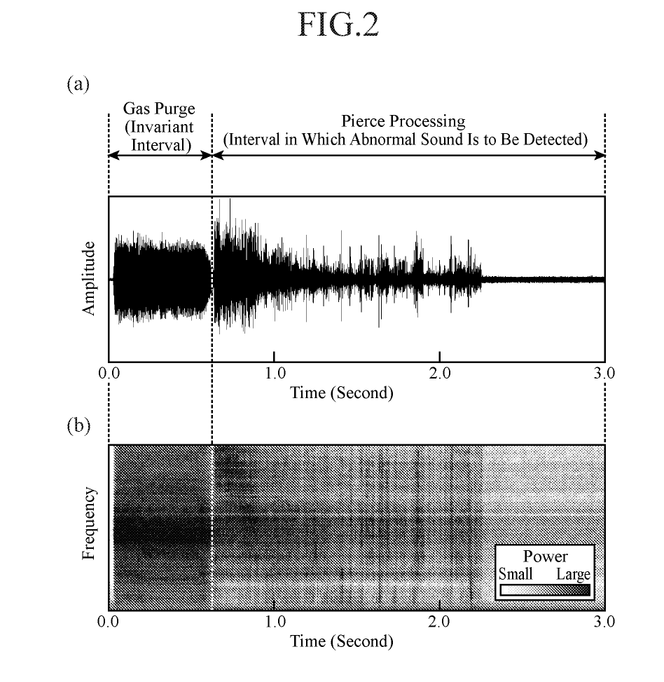

Next, a concrete example of the invariant interval will be described when the equipment 20 is a laser processing machine. In the laser processing machine, the invariant interval corresponds to the process of gas purge which is performed at the initial stage of the processing before piercing or cutting processing. The gas purge is a process in which the laser processing machine discharges unnecessary gas and causes a hissing sound “sss . . . ”. FIG. 2 is a diagram showing an operation sound when the laser processing machine carries out the gas purge and piercing. FIG. 2(a) shows a time waveform, and FIG. 2(b) shows its spectrogram, both of which plot the operation sound of the laser processing machine for three seconds from the start of the processing. As shown in FIG. 2, the gas purge is carried out first at the processing starting time, followed by the piercing.

Although the gas purge is performed ahead of the various laser processing, since it is the discharge of the unnecessary gas, it has nothing to do with the fulfillment of the laser processing. Accordingly, during the gas purge, the same operation sound is produced each time regardless of whether the following laser processing is carried out normally or not. Thus, as for the laser processing machine, the duration of the gas purge is employed the invariant interval, and the operation sound of the gas purge is used as a reference for correcting the observation signal of the sensor 30, that is, as a correction parameter.

The switch 2, referring to a decision result of the invariant interval deciding unit 1, switches the destination of the observation signal of the sensor 30 between the correction parameter generator 3 and the feature extracting unit 4. More specifically, while the invariant interval deciding unit 1 makes a decision of the invariant interval, it transmits the observation signal of the sensor 30 to the correction parameter generator 3, and while it makes a decision of an interval other than the invariant interval, that is, an interval to be used as a target of the abnormal sound detection (referred to as “abnormal sound detection target interval” from now on), the switch 2 transmits the observation signal of the sensor 30 to the feature extracting unit 4. According to the switching of the destination of the observation signal, the correction parameter generator 3 creates the correction parameter from the input observation signal only during the invariant interval.

The correction parameter generator 3 creates the parameter for correcting the sensor 30 in accordance with the observation signal of the sensor 30 during the invariant interval. The following description will be made using an example which corrects the sensor 30 by a method of the time domain. Incidentally, a method of correcting the sensor 30 by a method of the frequency domain will be described in an embodiment 2.

The correction parameter generator 3 computes the RMS (Root Mean Square) a of the observation signal of the sensor 30 in the invariant interval according to the following Expression (1).

$$a = \sqrt{\frac{1}{{t}_{end} - {t}_{start} + 1} {\sum }_{t = {t}_{start}}^{{t}_{end}} {\{ x ( t ) \}}^{2}} \qquad ( 1 )$$

In Expression (1), x(t) is the observation signal at time t, tₛₜₐᵣₜ is the starting time of the invariant interval, and t_{end} is the ending time of the invariant interval. At this time, the RMS a is a value corresponding to the mean amplitude of the observation signal during the invariant interval.

Then, the correction parameter generator 3 computes the correction coefficient c of the observation signal by calculating the reciprocal of the RMS a using the following Expression (2).

$$c = \frac{1}{a} \qquad ( 2 )$$

The correction coefficient c computed is supplied to the feature extracting unit 4 as the correction parameter.

The feature extracting unit 4 extracts the feature value of the observation signal according to the observation signal of the sensor 30 and the correction parameter. More specifically, using the observation signal x(t) supplied from the sensor 30 via the switch 2 and the correction coefficient c created by the correction parameter generator 3, the feature extracting unit 4 calculates the observation signal y(t) corrected according to the following Expression (3).

y(t)=cx(t) (3)

In Expression (3), the observation signal y(t) can be considered as the observation signal normalized in such a manner that the mean amplitude during the invariant interval becomes one.

Accordingly, even when the feature extracting unit 4 uses a feature extraction method depending on the type of the sensor and the setting conditions, it can extract the feature value independent of the type of the sensor or the setting conditions through the feature extraction using the corrected observation signal y(t) instead of the observation signal x(t). Thus, as long as the operation sound the equipment 20 generates is the same, the feature extracting unit 4 extracts the same feature value regardless of the type of the sensor or the setting conditions. Thus, it is unnecessary for the threshold the abnormal sound deciding unit 5 sets, which will be described later, to be set again even if the type of the sensor or the setting conditions are altered. As the feature extraction method of the abnormal sound in the time domain, a method disclosed in the Patent Document 1 or 2 or the like is applicable, for example.

The abnormal sound deciding unit 5, referring to the feature value the feature extracting unit 4 extracts, decides whether the abnormal sound is produced or not. As for the abnormal sound decision, it decides that the equipment 20 produces the abnormal sound if the feature value the feature extracting unit 4 extracts is not less than the threshold, and that the equipment 20 operates normally when the feature value is less than the threshold. If the abnormal sound deciding unit 5 decides that the abnormal sound is produced, it outputs the control signal to shut down the laser processing machine in an emergency, or gives abnormality information for notifying an operator of the abnormality by an alarm or the like. Incidentally, as for the processing operation when the operation sound is decided as abnormal, various methods other than the foregoing method are applicable.

Next, the operation of the abnormal sound detection device 10 will be described.

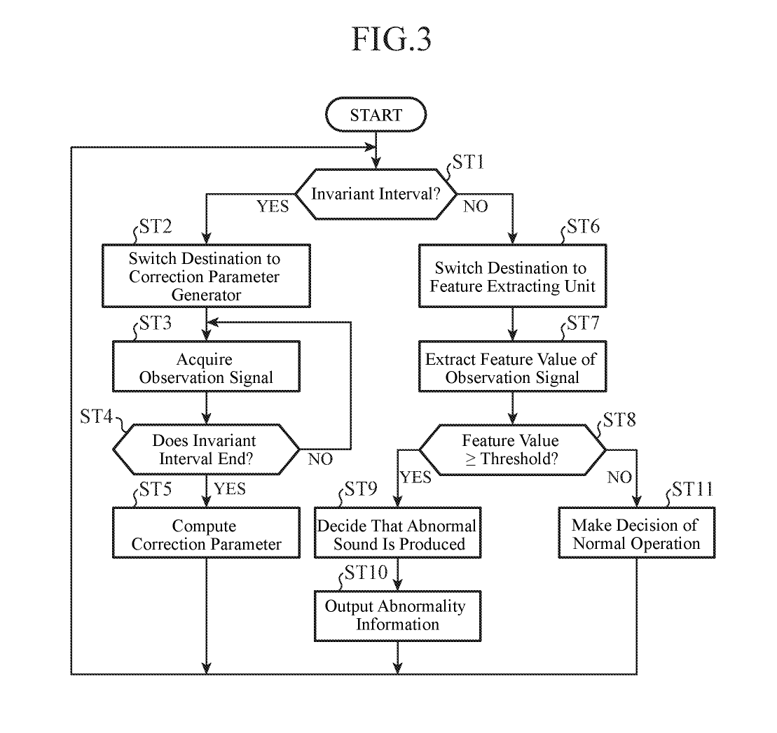

FIG. 3 is a flowchart showing the operation of the abnormal sound detection device of the embodiment 1 in accordance with the present invention.

The invariant interval deciding unit 1 decides whether the operation of the equipment 20 is in the invariant interval or not by referring to the state information of the equipment 20 (step ST1). When it decides that the operation of the equipment 20 is in the invariant interval (YES at step ST1), the switch 2 switches the destination of the observation signal supplied from the sensor 30 to the correction parameter generator 3 (step ST2). The correction parameter generator 3 acquires the observation signal supplied via the switch 2 (step ST3), and decides whether the invariant interval terminates or not by referring to the observation signal (step ST4). If the invariant interval has not yet terminated (NO at step ST4), the processing is returned to step ST3. On the other hand, if the invariant interval has terminated (YES at step ST4), the correction parameter generator 3 computes the correction coefficient which is the correction parameter using the observation signal it acquires at step ST3 (step ST5). The correction coefficient is supplied to the feature extracting unit 4, and the processing is returned to step ST1.

On the other hand, if the invariant interval deciding unit 1 decides that the operation of the equipment 20 is not in the invariant interval, that is, in the abnormal sound detection target interval (NO at step ST1), the switch 2 switches the destination of the observation signal supplied from the sensor 30 to the feature extracting unit 4 (step ST6). Using the observation signal delivered from the switch 2 and the correction coefficient computed at step ST5, the feature extracting unit 4 extracts the feature value of the observation signal (step ST7). The abnormal sound deciding unit 5 decides whether the feature value of the observation signal extracted at step ST7 is not less than the threshold or not (step ST8). If it is not less than the threshold (YES at step ST8), the abnormal sound deciding unit 5 decides that the abnormal sound is produced in the equipment 20 (step ST9), outputs the abnormality information (step ST10), and returns the processing to step ST1. On the other hand, if the feature value is less than the threshold (NO at step ST8), the abnormal sound deciding unit 5 decides that the equipment 20 operates normally (step ST11), and returns the processing to the decision processing at step ST1.

Incidentally, although the foregoing example shows a case where the abnormal sound deciding unit 5 outputs the abnormality information at step ST10, a configuration is also possible which outputs to the equipment 20 a control signal for shutting it down in an emergency.

As described above, according to the present embodiment 1, it is configured in such a manner that it comprises the invariant interval deciding unit 1 to decide the invariant interval of the equipment 20; the correction parameter generator 3 to compute the correction parameter from the observation signal of the sensor 30 supplied via the switch 2 during the invariant interval; the feature extracting unit 4 to extract the feature value from the observation signal of the sensor 30 supplied via the switch 2 in the interval other than the invariant interval and from the correction parameter; and the abnormal sound deciding unit 5 to decide whether the observation signal of the sensor 30 indicates the abnormal sound or not from the feature value extracted. Accordingly, it can carry out the feature extraction independent of the type of the sensor 30 and the setting conditions. This enables preventing the reduction in the abnormal sound detection capability due to the restriction of the feature extraction method.

In addition, according to the present embodiment 1, it is configured in such a manner that the correction parameter generator 3 computes as the correction coefficient the reciprocal of the mean amplitude of the observation signal of the sensor 30 during the invariant interval; and the feature extracting unit 4 carries out the feature extraction according to the signal resulting from multiplying the observation signal of the sensor 30 by the correction coefficient. Accordingly, it can perform the feature extraction from the observation signal normalized by the mean amplitude during the invariant interval, and even if it observes the operation sound with the same amplitude with the sensor in different setting conditions, it can extract the same feature value, thereby being able to prevent the reduction in the detection capability.

In addition, according to the present embodiment 1, a configuration is possible in which the equipment 20 transmits the trigger signal only at the starting time of the invariant interval, and the invariant interval deciding unit 1 sets a prescribed time interval from receiving the trigger signal in the processing as the invariant interval. Accordingly, it is enough for the equipment 20 to give information only about the processing starting time, and hence the present embodiment 1 can simplify the configuration of the abnormal sound detection device 10.

In addition, according to the present embodiment 1, it is configured in such a manner that when the laser processing machine is employed as the equipment 20, the gas purge interval which is independent of whether the laser processing is carried out normally or not is made the invariant interval, and that the abnormal sound detection device 10 acquires the observation signal of the invariant interval and creates the correction parameter. Accordingly, it can create the proper correction parameter and improve the detection accuracy of the processing abnormality.

Incidentally, as for the invariant interval deciding unit 1, switch 2, correction parameter generator 3, feature extracting unit 4, and abnormal sound deciding unit 5 of the foregoing embodiment 1, they can be implemented by means of an AD converter for converting the observation signal of the sensor 30 to a digital signal, a computer with a receiver of the trigger signal transmitted from the equipment 20 at the starting time and ending time of the invariant interval, and software operating on the computer.

### Embodiment 2

Although the foregoing embodiment 1 shows a configuration that corrects the observation signal of the sensor 30 in the time domain, the present embodiment 2 shows a configuration that corrects the observation signal of the sensor 30 in the frequency domain. Incidentally, since the block diagram of the abnormal sound detection device 10 of the embodiment 2 is the same as that of the embodiment 1, the block diagram is omitted, and the same reference symbols as those of FIG. 1 are used and their description will be omitted or simplified.

The correction parameter generator 3 computes a mean amplitude spectrum A(ω) of the observation signal of the sensor 30 in the invariant interval for each discrete frequency according to the following Expression (4).

$$A ( ω ) = \frac{1}{{k}_{end} - {k}_{start} + 1} {\sum }_{k = {k}_{start}}^{{k}_{end}} \vert {X}_{k} ( ω ) \vert \qquad ( 4 )$$

In Expression (4), ω is a frequency bin number, Xₖ (ω) is a discrete Fourier transform of a kth short-time frame of the observation signal, kₛₜₐᵣₜ is the first frame number of the invariant interval, and k_{end} is the final frame number of the invariant interval.

Next, to prevent the correction parameter from being specialized in the invariant interval too much, the correction parameter generator 3 obtains an amplitude spectrum S(ω) resulting from smoothing the mean amplitude spectrum A(ω) in the frequency axis direction using the following Expression (5).

$$S ( ω ) = \frac{1}{2 n + 1} {\sum }_{ψ = ω - n}^{ω + n} A ( ψ ) \qquad ( 5 )$$

In Expression (5), n is the strength of the smoothing by moving averages.

Finally, the correction parameter generator 3 computes the reciprocal of the amplitude spectrum S(ω) using the following Expression (6) to obtain the correction coefficient C(ω). Then it delivers the correction coefficient C(ω) to the feature extracting unit 4 as the correction parameter.

$$C ( ω ) = \frac{1}{S ( ω )} \qquad ( 6 )$$

Using the observation signal Xₖ (ω) supplied from the sensor 30 via the switch 2 and the correction coefficient C(ω) created by the correction parameter generator 3, the feature extracting unit 4 computes the observation signal Yₖ (ω) corrected according to the following Expression (7).

Yₖ(ω)=C(ω)Xₖ(ω) (7)

Using the observation signal Yₖ (ω) it computes, the feature extracting unit 4 carries out the feature extraction. Thus, it can extract the feature value independent of the type of the sensor 30 and the setting conditions. As the feature extraction method of the abnormal sound in the frequency domain, a method such as disclosed in the Patent Document 3 is applicable.

Correcting the observation signal of the sensor 30 in the frequency domain has an advantage of being able to correct not only the plain sensitivity of the sensor 30, but also its frequency characteristics. However, when the operation sound in the invariant interval has an extremely small frequency component in terms of power, it is likely that the correction coefficient diverges to infinity. Accordingly, as for the operation sound in the invariant interval, it is desirable that its power be distributed over a frequency as broad as possible (close to white noise).

Although the abnormal sound detection device 10 of the embodiment 2 is applicable to an apparatus other than the laser processing machine, applying it to the laser processing machine offers several particular advantages.

For example, considering the spectrum in the gas purge (invariant interval) shown in FIG. 2(b) of the embodiment 1, it shows that its power is distributed over the entire region observable, which means that it approaches white noise. Accordingly, it can be said that it is suitable for the correction of the sensor 30 in the frequency domain.

In addition, in the laser processing machine, its movable part called processing head usually comprises a lens for condensing laser rays and a gas vent (nozzle). Since the processing head moves every time of processing, the distance between the irradiation point of a laser, which is the main source of the operation sound during the processing, and the sensor varies every time of the processing. Although the variation of the distance is likely to affect the feature value, since the condenser lens and the nozzle are placed at nearly the same position, the gas purge sound is produced from the immediate vicinity of the irradiation point of the laser. Accordingly, the correction performed every time of the processing by the abnormal sound detection device 10 of the embodiment 2 corresponds to the correction of the variation in the observation signal based on the variation of the location of the laser irradiation point. As a result, an advantage can be expected of correcting the observation signal including the influence exerted on the feature value by the position of the processing head.

As described above, according to the present the present embodiment 2, it is configured in such a manner as to comprise the correction parameter generator 3 to create as the correction coefficient the reciprocal of the mean amplitude of the frequency spectrum of the observation signal in the invariant interval. Accordingly, it can carry out the correction not only of the plain sensitivity of the sensor 30, but also of the frequency characteristics, thereby being able to generate a more accurate correction parameter.

Incidentally, the foregoing example of the laser processing machine assumes that the difference in the operation sound which does not originate from the difference between the normal operation and the abnormal operation (referred to as a “random component” from now on) is small enough in the invariant interval of the detection target. The random component occurs from instability of the operation of the equipment or from external noise. If the random component of the detection target is not negligible, the correction parameter generator 3 supplies, when it creates the correction parameters, the feature extracting unit 4 with a plurality of correction parameters it created in the past and the mean value of the correction parameters it creates newly. Thus the random component is smoothed, which enables stable feature extraction.

### Embodiment 3

Although the foregoing embodiment 1 and embodiment 2 show an example that applies the abnormal sound detection device to the laser processing machine, the present embodiment 3 explains an example that applies the abnormal sound detection device to an NC cutting machine. Incidentally, since a block diagram of the abnormal sound detection device 10 of the embodiment 3 is the same as that of the embodiment 1 or embodiment 2, its block diagram is omitted, and the same reference symbols as those in FIG. 1 are used and their description will be omitted or simplified.

First, an NC cutting machine is a processing machine for automatically cutting a workpiece by numerical control using a drill or the like. When using a drill in the cutting processing, there are some cases where the processing quality deteriorate owing to drill wear, for example, and the operation sound at the cutting varies between the normal case (when the drill is not worn) and the abnormal case (when the drill is worn out). Accordingly, the abnormal sound detection device 10 detects an abnormality by deciding that the operation sound at the cutting with the worn drill is an abnormal sound.

The NC cutting machine performs initial acceleration to increase the rotation speed of the drill before cutting a workpiece at the starting time of the processing. Since the drill does not make contact with the workpiece at the initial acceleration, the same operation sound occurs on every occasion independently of the normal operation or abnormal operation at the cutting. Accordingly, using the initial acceleration duration as the invariant interval, the abnormal sound detection device 10 can make an abnormal sound decision of the NC cutting machine.

As described above, according to the present embodiment 3, it is configured in such a manner as to comprise the invariant interval deciding unit 1 to designate the initial acceleration duration at the processing starting time as the invariant interval, and to decide whether the present time is in the invariant interval or not by referring to the state information supplied from the equipment 20 consisting of the NC cutting machine. Thus, the abnormal sound detection device 10 is applicable to any processing machine in general without being limited to the laser processing machine.

In addition, according to the present embodiment 3, when the NC cutting machine is applied as the equipment 20, the abnormal sound detection device 10 designates as the invariant interval the initial acceleration time, during which the drill does not make contact with the workpiece and hence produces the same operation sound at every occasion independently of whether the cutting is performed normally or not, and creates the correction parameter by acquiring the observation signal in the invariant interval. Thus, it can create the proper correction parameter, thereby being able to improve the detection accuracy of a cutting abnormality.

### Embodiment 4

The present embodiment 4 shows a configuration for detecting an occurrence of an abnormality in the equipment 20 in the invariant interval in addition to the configuration of the foregoing embodiment 1 to embodiment 3.

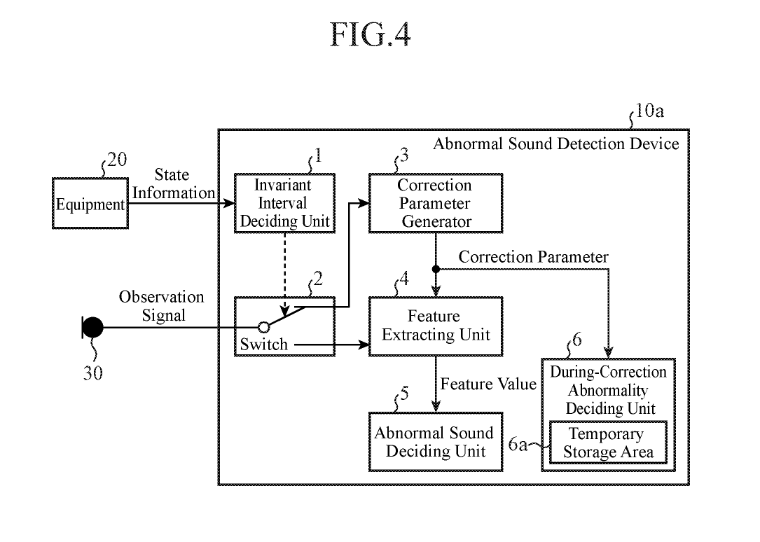

FIG. 4 is a block diagram showing a configuration of an abnormal sound detection device of the embodiment 4 in accordance with the present invention.

The abnormal sound detection device 10a of the embodiment 4 comprises a during-correction abnormality deciding unit 6 in addition to the abnormal sound detection device 10 of the embodiment 1 shown in FIG. 1. Incidentally, the same or like components as those of the abnormal sound detection device 10 of the embodiment 1 are designated by the same reference symbols as those used in FIG. 1, and their description will be omitted or simplified.

The during-correction abnormality deciding unit 6 comprises a temporary storage area 6a, compares a correction parameter stored in the temporary storage area 6a in advance with the correction parameter the correction parameter generator 3 creates, and decides whether an abnormality occurs in the invariant interval or not. If an abnormality occurs in the invariant interval, the during-correction abnormality deciding unit 6 outputs a control signal for shutting down the equipment 20 due to an emergency, or outputs abnormality information for notifying an operator of the abnormality by an alarm. Incidentally, as for the processing operation when a decision is made that an abnormality occurs in the invariant interval, various methods other than the foregoing one are applicable.

The processing operation of the during-correction abnormality deciding unit 6 will be described in more detail. First, the correction parameter generator 3 creates the correction parameter every time the invariant interval occurs, and supplies it to the during-correction abnormality deciding unit 6. The during-correction abnormality deciding unit 6 overwrites and saves the most recent correction parameter used for the decision processing in the temporary storage area 6a. This is done for referring to it when comparing it with the correction parameter in the next invariant interval. When receiving the new correction parameter from the correction parameter generator 3, the during-correction abnormality deciding unit 6 compares the correction parameter received with the correction parameter stored in the temporary storage area 6a, and computes the difference between the parameters. If the difference between the parameters computed is not less than a preset threshold, it decides that an abnormality occurs in the invariant interval.

Next, the operation of the abnormal sound detection device 10a will be described.

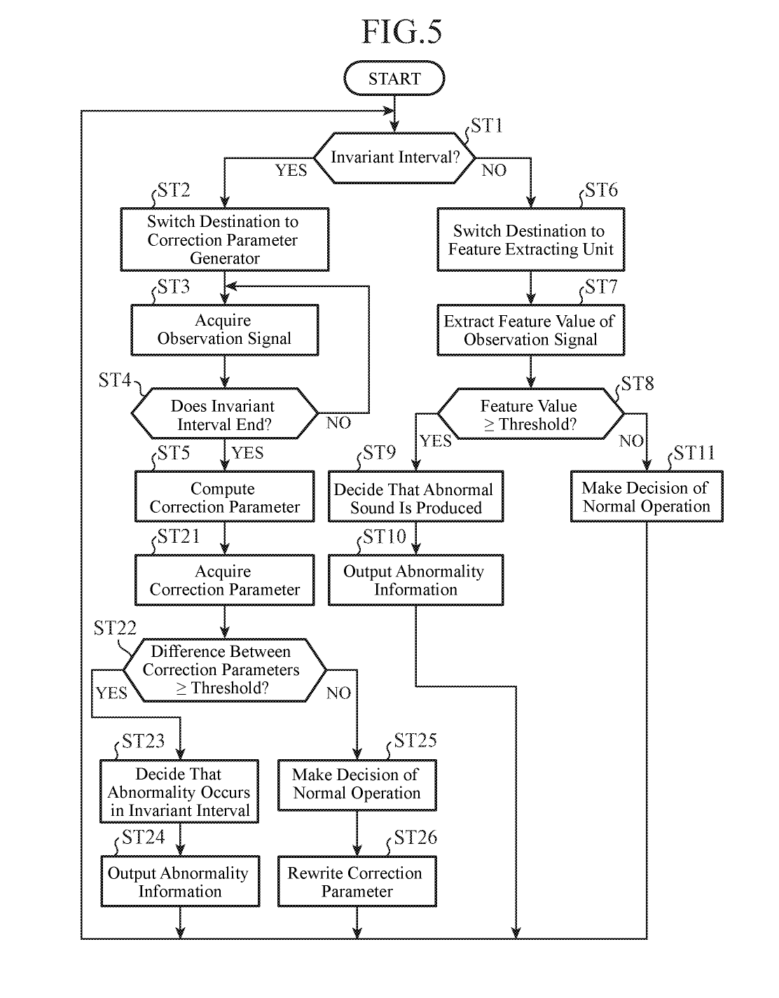

FIG. 5 is a flowchart showing the operation of the abnormal sound detection device of the embodiment 4 in accordance with the present invention.

Incidentally, in the following description, the same steps as those of FIG. 3 showing the operation of the abnormal sound detection device 10 of the embodiment 1 are designated by the same reference symbols, and their description will be omitted or simplified.

When the correction parameter generator 3 computes the correction coefficient as the correction parameter by using the observation signal it acquires at step ST3 (step ST5), the correction coefficient computed is delivered to the feature extracting unit 4 and during-correction abnormality deciding unit 6. When the during-correction abnormality deciding unit 6 acquires the correction parameter created at step ST5 (step ST21), it computes the difference between the correction parameter and the correction parameter stored in the temporary storage area 6a in advance, and decides whether the difference between the parameters computed is not less than the predetermined threshold or not (step ST22).

If the difference between the parameters is not less than the threshold (YES at step ST22), the during-correction abnormality deciding unit 6 decides that an abnormality occurs in the equipment 20 in the invariant interval (step ST23), and outputs abnormality information (step ST24). On the other hand, when the difference between the parameters is less than the threshold (NO at step ST22), it decides that the equipment 20 operates normally in the invariant interval (step ST25). After that, the during-correction abnormality deciding unit 6 overwrites and saves the correction parameter it acquires at step ST21 in the temporary storage area 6a (step ST26), and returns to the processing at step ST1.

Applying the abnormal sound detection device 10a of the embodiment 4 to a laser processing machine presents a problem in that when an exhaust pressure of the laser processing machine decreases owing to an abnormality of its gas purge and the sound pressure in the invariant interval reduces, the correction coefficient the correction parameter generator 3 creates increases so that the observation signal corrected using the correction coefficient takes a relatively large value as well. However, applying the abnormal sound detection device 10a of the embodiment 4 to the laser processing machine makes it possible to detect the reduction in the sound pressure in the invariant interval as the occurrence of the abnormality, and thus to enable preventing the foregoing problem.

As described above, according to the present embodiment 4, since it is configured in such a manner as to comprise the during-correction abnormality deciding unit 6 to detect the abnormality of the equipment 20 in the invariant interval, it can cope with a wider variety of abnormality of the equipment 20.

Incidentally, although the foregoing embodiment 1 to embodiment 4 show a configuration comprising the switch 2, a configuration is also possible in which the switch 2 is not provided, and the correction parameter generator 3 and the feature extracting unit 4 refer to the decision result of the invariant interval deciding unit 1 separately, and carry out the correction parameter generation and the feature extraction, respectively.

Incidentally, although the foregoing embodiment 1 to embodiment 4 show an example of the abnormal sound detection of the laser processing machine or NC cutting machine as the equipment 20, the abnormal sound detection device in accordance with the present invention is not limited to the application to those apparatuses, but is applicable to any equipment that produces an operation sound different at the normal time and the abnormality time.

Incidentally, it is to be understood that a free combination of the individual embodiments, variations of any components of the individual embodiments or removal of any components of the individual embodiments is possible within the scope of the present invention.

### INDUSTRIAL APPLICABILITY

An abnormal sound detection device in accordance with the present invention is capable of feature extraction independently of the type of the sensor or setting conditions. Accordingly, it is suitable for an application to an NC processing machine or the like to prevent the reduction in the abnormal sound detection capability due to the type of the sensor or the setting conditions.

### DESCRIPTION OF REFERENCE SYMBOLS

1 invariant interval deciding unit; 2 switch; 3 correction parameter generator; 4 feature extracting unit; 5 abnormal sound deciding unit; 6 during-correction abnormality deciding unit; 6a temporary storage area; 10, 10a abnormal sound detection device; 20 equipment; 30 sensor.

What is claimed is:

1. An abnormal sound detection device for detecting an abnormal sound from an operation sound of a detection target, the abnormal sound detection device comprising;
an invariant interval deciding unit to decide whether an operation of the detection target is an operation in an invariant interval or not by referring to state information indicating an operation state of the detection target, the invariant interval being a time interval in which an operation sound makes no difference whether the operation sound originates from a normal operation or from an abnormal operation of the detection target;
a correction parameter generator to create, when the invariant interval deciding unit decides that the operation of the detection target is the operation in the invariant interval, a correction parameter for correcting an observation signal of the detection target in a time interval outside the invariant interval from an observation signal obtained by observing the operation sound of the detection target in the invariant interval;
a feature extracting unit to extract, when the invariant interval deciding unit decides that the operation of the detection target is the operation in the time interval outside the invariant interval, a feature value of the operation sound of the detection target in the time interval outside the invariant interval in accordance with the observation signal of the detection target in the time interval outside the invariant interval and the correction parameter the correction parameter generator creates; and
an abnormal sound deciding unit to decide whether the abnormal sound occurs in the detection target or not in accordance with the feature value the feature extracting unit extracts.

2. The abnormal sound detection device according to claim 1, wherein
the correction parameter generator computes a reciprocal of mean amplitude of the observation signal as the correction parameter.

3. The abnormal sound detection device according to claim 1, wherein
the correction parameter generator computes a reciprocal of a mean amplitude spectrum of the observation signal as the correction parameter.

4. The abnormal sound detection device according to claim 1, further comprising:
a switch to acquire an observation signal of the detection target supplied from external equipment, and to switch an output destination of the observation signal of the detection target between the correction parameter generator and the feature extracting unit in response to a decision result of the invariant interval deciding unit.

5. The abnormal sound detection device according to claim 1, wherein
the invariant interval deciding unit receives a trigger signal transmitted from the detection target at starting time and ending time of the invariant interval, and decides as the invariant interval an interval from receiving the trigger signal at the starting time of the invariant interval to receiving the trigger signal at the ending time.

6. The abnormal sound detection device according to claim 1, wherein
the invariant interval deciding unit receives a trigger signal transmitted from the detection target at starting time of the invariant interval, and decides as the invariant interval a prescribed time interval from receiving the trigger signal at the starting time of the invariant interval.

7. The abnormal sound detection device according to claim 1, further comprising:
a during-correction abnormality deciding unit to compute difference between the correction parameter the correction parameter generator creates and a correction parameter stored in advance in a temporary storage area, and to decide whether or not an abnormality occurs in the detection target during the invariant interval in accordance with the difference computed.

8. An abnormal processing-machine-sound detection system having a processing machine which is an abnormal sound detection target, a sensor for observing operation sound of the processing machine, and an abnormal sound detection device for detecting an abnormal sound from the operation sound of the processing machine the sensor observes, wherein
the processing machine outputs state information indicating an operation state of the processing machine itself; and
the sensor observes the operation sound of the processing machine and outputs an observation signal, and wherein
the abnormal sound detection device comprises:
an invariant interval deciding unit to decide whether an operation of the processing machine is an operation in an invariant interval or not by referring to the state information input from the processing machine, the invariant interval being a time interval in which the operation sound makes no difference whether the operation sound originates from a normal operation or from an abnormal operation of the processing machine;
a correction parameter generator to generate, when the invariant interval deciding unit decides that the operation of the processing machine is the operation in the invariant interval, a correction parameter for correcting an observation signal of the processing machine in a time interval outside the invariant interval using the observation signal in the invariant interval supplied from the sensor;
a feature extracting unit to extract, when the invariant interval deciding unit decides that the operation of the processing machine is the operation in the time interval outside the invariant interval, a feature value of the operation sound of the processing machine in the time interval outside the invariant interval in accordance with the observation signal in the time interval outside the invariant interval supplied from the sensor and the correction parameter the correction parameter generator creates; and
an abnormal sound deciding unit to decide whether an abnormal sound occurs in the processing machine in accordance with the feature value the feature extracting unit extracts.

9. The abnormal processing-machine-sound detection system according to claim 8, wherein
the processing machine is a laser processing machine which outputs the state information indicating that a process of discharging unnecessary gas is the operation in the invariant interval.

10. The abnormal processing-machine-sound detection system according to claim 8, wherein
the processing machine is an NC cutting machine which outputs the state information indicating that a process of carrying out initial acceleration before a cutting process is the operation in the invariant interval.

11. An abnormal sound detection method for detecting an abnormal sound from an operation sound of a detection target, the abnormal sound detection method comprising the steps of:
deciding, by an invariant interval deciding unit, whether an operation of the detection target is an operation in an invariant interval or not by referring to state information indicating an operation state of the detection target, the invariant interval being a time interval in which an operation sound makes no difference whether the operation sound originates from a normal operation or from an abnormal operation of the detection target;
creating, by a correction parameter generator, when the invariant interval deciding unit decides that the operation of the detection target is the operation in the invariant interval, a correction parameter for correcting an observation signal of the detection target in a time interval outside the invariant interval from an observation signal obtained by observing the operation sound of the detection target in the invariant interval;
extracting, by a feature extracting unit, when the invariant interval deciding unit decides that the operation of the detection target is the operation in the time interval outside the invariant interval, a feature value of the operation sound of the detection target in the time interval outside the invariant interval in accordance with the observation signal of the detection target in the time interval outside the invariant interval and the correction parameter; and
deciding, by an abnormal sound deciding unit, whether the abnormal sound occurs in the detection target or not in accordance with the feature value.
